(19) United States
(12) Patent Application Publication
(10) Pub. No.: US 2015/0172775 A1
(43) Pub. Date: Jun. 18, 2015

(54) SYSTEMS AND METHODS FOR IMMERSIVE VIEWING EXPERIENCE

(71) Applicant: The DIRECTV Group, Inc., El Segundo, CA (US)

(72) Inventors: WOEI-SHYANG YEE, IRVINE, CA (US); CHRISTOPHER YANG, TEMPLE CITY, CA (US); WESLEY W. HUIE, RIVERSIDE, CA (US); GERARD V. TALATINIAN, FOOTHILL RANCH, CA (US)

(73) Assignee: THE DIRECTV GROUP, INC., El Segundo, CA (US)

(21) Appl. No.: 14/106,242

(22) Filed: Dec. 13, 2013

(51) Int. Cl. H04N 21/485

(52) U.S. Cl. CPC H04N 21/485

(57) ABSTRACT

Described herein are methods and systems that may help to provide selectable viewing options for a television program. An exemplary method involves: (i) receiving a television video transport stream comprising video content associated with a particular television program, wherein the television video transport stream comprises focal-point metadata regarding at least one focus point, wherein the at least one focus point corresponds to a sub-frame within at least one frame of the video content, (ii) receiving focal-point input data indicating a zoom request, (iii) processing video content in response to the focal-point input data, and (iv) generating a television video output signal comprising video content that is zoomed to the sub-frame, wherein the television video output signal is configured to be displayable on a graphic display.

### BACKGROUND

Generally, a television broadcast system provides video, audio, and/or other data transport streams for each television program. A consumer system, such as a tuner, a receiver, or a set-top box, receives and processes the transport streams to provide appropriate video/audio/data outputs for a selected television program to a display device (e.g., a television, projector, laptop, tablet, smartphone, etc.).

The transport streams may be encoded. For instance, some broadcast systems utilize the MPEG-2 format that includes packets of information, which are transmitted one after another for a particular television program and together with packets for other television programs. Metadata related to particular television programs can be included within a packet header section of an MPEG-2 packet. Metadata can also be included in separate packets of an MPEG-2 transmission (e.g., in MPEG-2 private section packets, and and/or in an advanced program guide transmitted to the receiver). This metadata can be used by the consumer system to identify, process, and provide outputs of the appropriate video packets for each selectable viewing option.

### SUMMARY

Example embodiments may help to provide selectable television viewing options; for example, by allowing a user to zoom in on different points of interest in a television program. Illustratively, a video stream that is broadcast on a particular television channel may provide a wide field of view of a baseball game, such as an overhead view of the playing field. Provided with an example embodiment, a user may be able to select a point interest in the video stream, such as the current batter, and the receiver will zoom in on the point of interest and provide a video output with the point of interest featured or centered in the display. In a further aspect, a user interface may allow a user to select the particular points of interest that the user would like to zoom in on. The user interface, in one example, can be a graphical user interface that is provided on the display, although, other examples are also possible.

Further, to facilitate such functionality, a television service provider's system may insert focus-point metadata into the video stream. A focus point may be a coordinate pair in the video frame that is updated to follow the point of interest as it moves within the video frame. As such, a coordinate pair for a given frame of the video content may indicate a sub-frame within the given frame, such that the receiver can determine an appropriate area in each frame to zoom in on. Accordingly, in response to receiving a request to zoom to a point of interest, a consumer system, such as a set-top box, may process the video content to generate video content that is zoomed in on a sub-frame surrounding the point of interest.

In one aspect, an example method involves receiving a television video transport stream with video content associated with a particular television channel, where the television video transport stream includes focal-point metadata regarding one or more focus points that follow the point of interest, where a focus point is a coordinate that follows the point of interest and indicates a sub-frame within a frame of the video content. In response to receiving a request to zoom to a point of interest, the video content is processed, and a television signal is generated with video content that is zoomed to the sub-frame.

In another aspect, an example method involves receiving two or more television video transport streams with video content for a particular program. The two or more television video transport streams include video content associated with two or more different camera views of the particular television program, and at least one of the television video transport streams includes a focus point that follows a point of interest and indicates a sub-frame at least one frame of the video content. Then a camera selection request is received or a zoom request is received. In response to one or both of the camera selection request or the zoom request, the video content is processed and a television video output signal is generated that is associated with one or both of the camera selection request or the zoom request.

In a further aspect, an example method involves receiving two or more television video transport streams with video content for a particular program. The two or more television video transport streams include video content associated with two or more different camera views of the particular television program. After identifying the different camera views, a camera selection request is received. In response to the camera selection request, the video content is processed and a television video output signal is generated with video content that is associated with the camera selection request.

In yet another aspect, an example method involves receiving streaming data comprising video content associated with at least one live stream for a particular television program and generating a focus point that follows a point of interest and indicates a sub-frame within at least one frame of the video content. Then, a television video transport stream is generated with video content that includes the focus point that follows the point of interest, and the television video transport stream is transmitted by way of a single television channel.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a block diagram illustrating a television system, according to an example embodiment.

FIG. 2 is another block diagram illustrating a television system, according to an example embodiment.

FIG. 3A illustrates an example embodiment of a broadcast system 120;

FIG. 3B illustrates an example embodiment of a consumer system 130;

FIG. 4 illustrates a metadata structure providing data regarding a focus point and movement data and, in particular, for Ultra HD video streams;

FIG. 5 illustrates a data format for identifying metadata within a packetized system and, in particular, a data format for standard definition and high definition video streams;

FIGS. 6A, 6B, and 6C illustrate an example display with a graphical user interface for zooming in on different points of interest of a video stream;

FIGS. 7A and 7B illustrate an example display with a graphical user interface for zooming in on different points of interest of a video stream.

FIG. 8 illustrates another method designed for implementation with an MPEG-2 transport stream.

FIG. 9 illustrates a simplified block diagrammatic view of a receiver, according to an example embodiment.

FIG. 10 illustrates a simplified block diagrammatic view of a server, according to an example embodiment.

### DETAILED DESCRIPTION

Exemplary methods and systems are described herein. It should be understood that the word “exemplary” is used herein to mean “serving as an example, instance, or illustration.” Any embodiment or feature described herein as “exemplary” or as an “example” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

Additionally, the particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

### I. Overview

Example embodiments may help television content broadcasters and/or satellite or cable television providers to provide a user with selectable viewing options for a television program. For example, example embodiments may allow viewers to selectively track different points of interest in the television program. As a specific example, example embodiments may allow a user to track particular players in a sporting event or to track a particular item or object, such as a football, hockey puck, soccer ball, etc., which is used in the sporting event. The viewing options can also or alternatively include video from different camera locations and angles. Other examples are possible.

In example embodiments, the metadata can include video coordinates for different focus points within the video stream, where the focus points follow a point of interest and correspond to a sub-frame within a frame of video content. To facilitate selectable zooming, focus points can be defined by the broadcasters and/or by the satellite/cable television operators as video coordinates. Further, the video coordinates for the focus point can take various forms, such as a pair of (X₁, Y₁), (X₂, Y₂) coordinates that define opposing corners of a video box, or a single coordinate (X₁, Y₁) that defines a center of the focus point and where the video box can be a predefined or adjustable size.

In a further aspect, to facilitate zooming in on different points of interest, metadata can also track movement of the focus point. This movement metadata may include X-Y direction and magnitude data (e.g., X and Y vector data). Generally, the receiver can generate the vector data by processing subsequent video frames to determine the direction and magnitude of movement for the point of interest. The receiver can use such movement metadata to track the point of interest and provide a smooth video output with the point of interest featured or centered in the display.

The viewing options can also or alternatively provide a selection of multiple camera views; for instance, multiple views of the playing field in a sporting event. Further, separate focus points corresponding to the same point of interest may be provided for video content from multiple cameras, such that a user can zoom in on the same point of interest from multiple different camera views. In other words, although a point of interest (e.g., Player 2) is the same regardless of camera selection, each camera may have different focus points, or coordinates, that follow the respective point of interest and correspond to a sub-frame within a frame of the video content. Thus, after focusing on a particular player in a sporting event, a graphical user interface may be displayed that provides a selection of all cameras capable of focusing on that particular player.

Such selectable viewing options can be provided through different video streams that are provided synchronously via a single television channel. Illustratively, the television program can be a football game and the video streams for the football game can include a first camera view from behind an end zone, a second camera view from midfield, a third camera view that focuses on the football, and one or more other camera views that focus on specific players, player positions, or others (e.g., cornerbacks, the quarterback, running backs, coaches, band members, people in the stands, etc.). The video packets for each video stream are associated with camera view metadata so that the receiver can retrieve the appropriate video packets to display. As discussed generally above, the present disclosure contemplates a user interface through which a user can select one or more of the video streams to display. The selected video stream(s) can be displayed in a number of different ways, such as displaying a single selected video stream on the entire display or displaying different video streams in a picture-in-picture (PIP) arrangement or a split-screen arrangement.

The examples described above and throughout this description are provided for explanatory purposes and are not intended to be limited. It should be understood that variations on these examples, and different examples, are also possible.

### II. Exemplary Television Systems

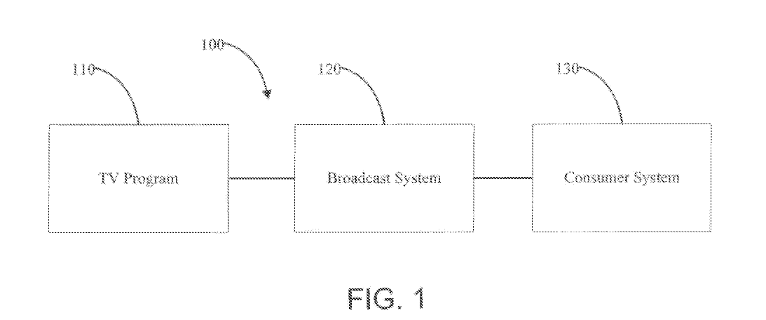

Turning now to FIG. 1, the reference numeral 100 generally indicates a system overview for broadcast television. A television program 110 may also be referred to as a television show, and may include a segment of content that can be broadcast on a television channel. There are may types of television programs 110, such as animated programs, comedy programs, drama programs, game show programs, sports programs, and informational programs. Television programs 110 can be recorded and broadcast at a later date. Television programs 110 may also be considered live television, or broadcast in real-time, as events happen in the present. Television programs 110 may also be distributed, or streamed, over the Internet. In an exemplary embodiment, the television programs may further include various points of interest, such as actors, athletes, and stationary objects such as a football, baseball, and goal posts, which can be zoomed in on using focus points that correspond to each point of interest.

Television programs 110 are generally provided to consumers by way of a broadcast system 120 and consumer system 130. There are many different types of broadcast systems 120, such as cable systems, fiber optic systems, satellite systems, and Internet systems. There are also a variety of consumer systems 130, including set-top box systems, integrated television tuner systems, and Internet-enabled systems. Other types of broadcast systems and/or consumer systems are also possible.

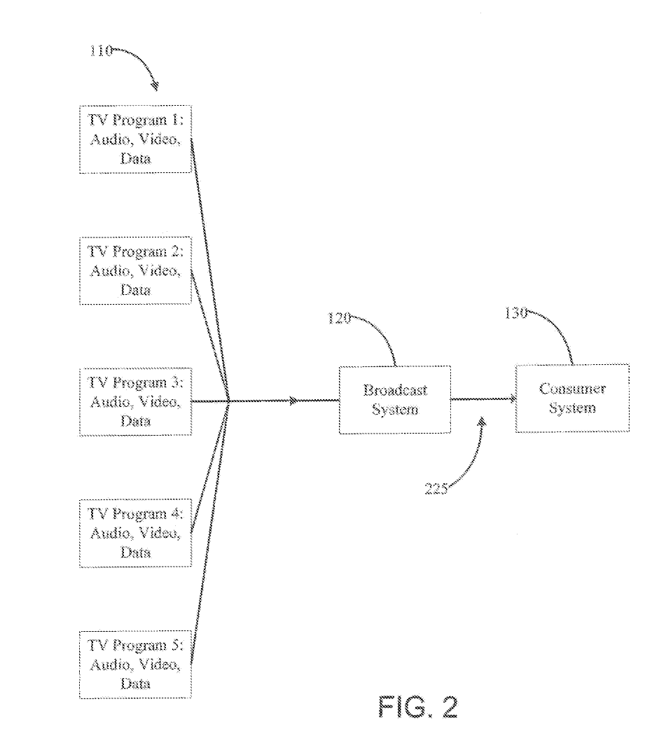

Turning now to FIG. 2, the broadcast system 120 may be configured to receive video, audio, and/or data streams related to a television program 110. The broadcast system 120 may also be configured to process the information from that television program 110 into a transport stream 225. The transport stream 125 may include information related to more than one television program 110 (but could also include information about just one television program 110). The television programs 110 are generally distributed from the broadcast system 120 as different television channels. A television channel may be a physical or virtual channel over which a particular television program 110 is distributed and uniquely identified by the broadcast system 120 to the consumer system 130. For example, a television channel may be provided on a particular range of frequencies or wavelengths that are assigned to a particular television station. Additionally or alternatively, a television channel may be identified by one or more identifiers, such as call letters and/or a channel number.

In an example embodiment, a broadcast system 120 may transmit a transport stream to the consumer system 130 in a reliable data format, such as the MPEG-2 transport stream. However, other formats for a transport stream are also possible. A transport stream may specify a container format for encapsulating packetized streams (such as encoded audio or encoded video), which facilitates error corrections and stream synchronization features that help to maintain transmission integrity when the signal is degraded.

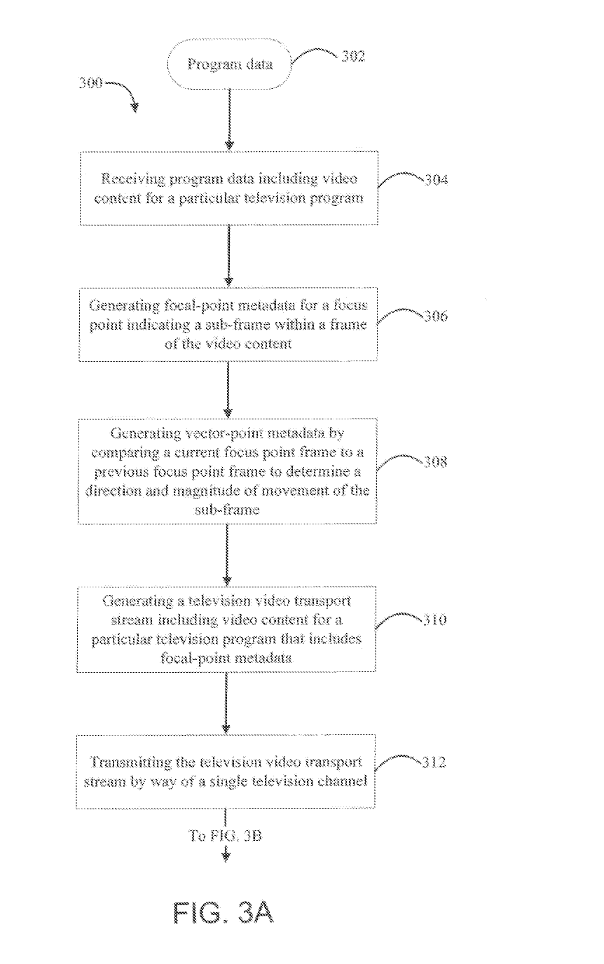

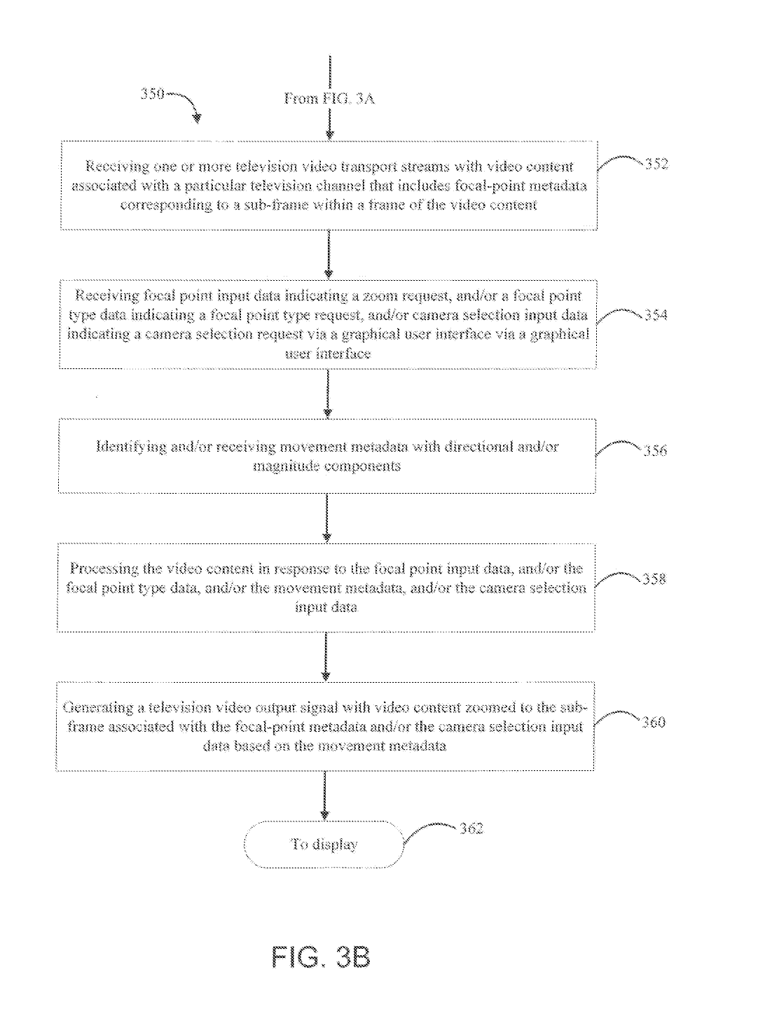

FIGS. 3A and 3B illustrate methods according to example embodiments. The methods 300 and 350 may be implemented by one or more components of the system 100 shown in FIG. 1, such as broadcasting system 120 and/or consumer system 130. At block 302, program data associated with a television program 110 is created. The program data is in the form of audio, video, and/or data associated with a television program 110. Examples of data associated with a television program include electronic programming guide information and closed captioning information.

At block 304, the broadcasting system 130 receives program data for a particular television program 110. At block 306, focal-point metadata is generated for a focus point that follows a point of interest and indicates a sub-frame within a frame of the video content from the program data. For example, the focal-point metadata may indicate a pair of coordinates that defines a sub-frame that is centered on the focal point. As a specific example, the focal-point metadata may be defined as (X₁, Y₁), (X₂, Y₂). Alternatively, the focal-point metadata may indicate a focal point (X₁, Y₁), such that a sub-frame of a pre-defined size can be centered on the focal point.

In an example embodiment, the broadcast system 120 may also generate movement data to anticipate movement of the point of interest and, correspondingly, the focus point. Such movement data may help to improve the picture quality when a user is viewing a sub-frame for a particular focus point that follows a particular point of interest. The movement data may be transmitted by the broadcast system 120 to the consumer system 130 in the form of a motion vector for the available points of interest. The point of interest may, for example, become the center or focus of the zoomed picture while the motion vector will provide direction on where the zoomed video will move until additional packets of video content are received by the consumer system 130.

For example, at block 308, vector metadata may be generated that indicates movement of a focus point that follows a point of interest in the sub-frame relative to the larger video frame of the video content. Such vector metadata may be generated by comparing a current focus point to a previous focus point, and determining the direction and magnitude of movement of the focus point. For example, if the focus point is defined as a center point, a direction of movement in the x-plane may be determined by subtracting a current focus point x-coordinate Xₜ from a previous focus pint x-coordinate Xₜ₋₁, where a positive result means the focus point is moving in the positive x-direction. Likewise, a magnitude of movement in the x-plane may be determined by taking the absolute value of the difference in the current focus point x-coordinate and the previous focus point x-coordinate. This approach can also be used to measure direction and magnitude of movement in other planes and for other types of metadata.

At block 310, the broadcast system 120 generates a television video transport stream that includes video content for one or more television programs 110 and includes focal-point metadata. In an example embodiment, the television video transport stream also includes vector metadata such as a direction of movement and a magnitude of movement. At block 312, the broadcast system 120 transmits the television video transport stream. For example, the broadcast system may transmits a television video transport stream that includes video content for one television program 110, including focal-point metadata and/or other metadata, by way of a single television channel.

The method 350 may be implemented by one or more components of a television system, such as the broadcasting system 120 and/or the consumer system 130 shown in FIG. 1. At block 352, the consumer system 130 receives one or more television video transport streams with video content associated with a particular television program 110. Each television video transport stream may include focal-point metadata, which indicates at least one focus point that follows a point of interest and indicates a sub-frame within a frame of the video content in the stream.

At block 354, the consumer system 130 receives focal-point input data indicating a zoom request for a point of interest. For example, if the television program is a football game, the consumer system 130 may display a graphical user interface with a list of the football player's names. The user may select the desired name from the graphical display, thus indicating a zoom request for a point of interest (i.e., the football player whose name was selected), and the consumer system 130 would associate the request with the focal-point input data.

At block 356, the consumer system 130 receives movement metadata for a focus point that indicates a direction of movement and/or a magnitude of movement, as described above, from the broadcast system 120. Alternatively, the consumer system 130 may generate movement metadata as described above.

At block 358, the consumer system processes 130 the video content in response to the focal-point input data and/or the movement metadata. Then, at block 360 the consumer system 130 generates a television video output signal with video content zoomed to the sub-frame associated with the focal-point metadata. In a further aspect, the consumer system 130 may improve the quality of the television video output signal by utilizing the movement metadata in combination with the focal-point input data.

At block 362, the consumer system 130 transmits the television video output signal with zoomed video content. The television video output signal can be configured to display the signal on a graphic display in various configurations. For example, the zoomed video content could be displayed as a full-screen arrangement. Alternatively, the zoomed video content could be displayed as a split-screen arrangement or as a picture-in-picture arrangement. Higher-resolution programs, for instance UltraHD resolutions, provide even more opportunities for interesting configurations. UltraHD resolutions include resolutions for displays with an aspect ratio of at least 16:9 and at least one digital input capable of carrying and presenting native video at a minimum resolution of 3,840 pixels by 2,160 pixels. UltraHD may also be referred to as UHD, UHDTV, 4K UHDTV, 8K UHDTV, and/or Super Hi-Vision.

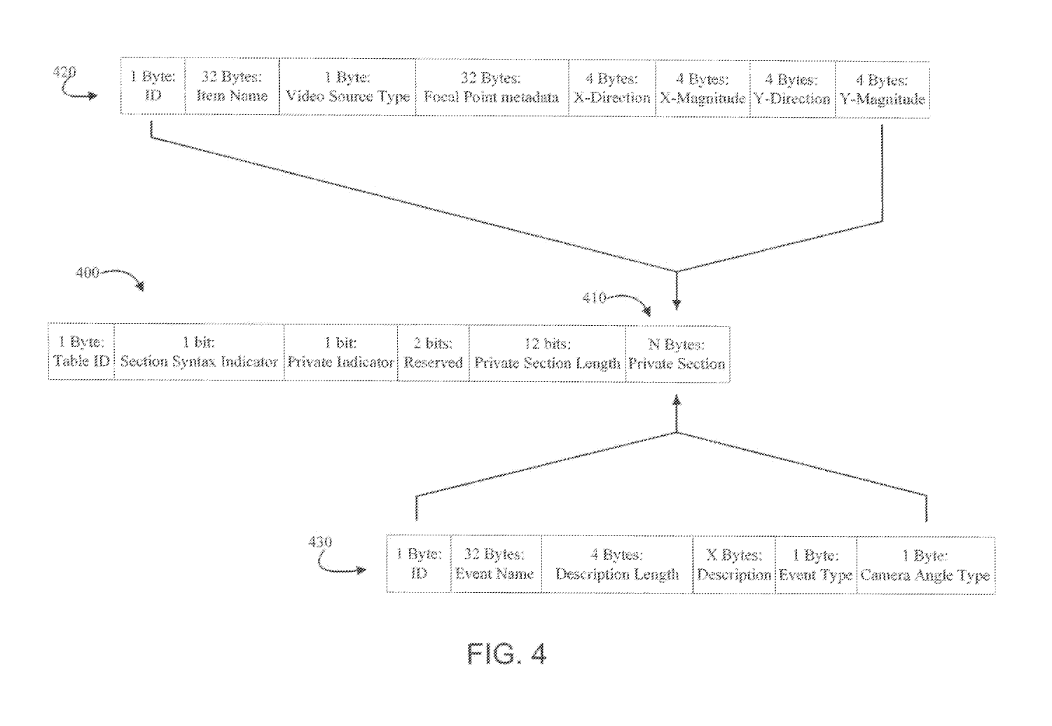

FIG. 4 is a block diagram illustrating packet-data formatting for a transport stream, according to an exemplary embodiment. In particular, FIG. 400 shows a data structure for a single packet 400 in a MPEG-2 transport stream, which may include standard definition or high definition video content 402 (not shown).

As shown packet 400 includes 1 byte of data that indicates a table identifier. Packet 400 further includes 1 bit of data as a section syntax indicator. The section syntax indicator may correspond to different packet structure formats. For example, a section syntax indicator value of ‘1’ may correspond to the data format for a packet 400 as illustrated in FIG. 4, while a section syntax indicator value of ‘0’ may correspond to a different data format for a packet 400 that may include different data syntax. In a further aspect, the different data syntax for a packet 400 may include blocks of data corresponding to a table identifier extension, a version number, a current next indicator, a section number, a last section number, and/or error correction data as provided by the MPEG-2 standard, other standards, or other formats.

The packet 400 may further include 1 bit of data that designates a private indicator. The packet 400 may further include 2 bits of data that are reserved. The packet 400 may further include 12 bits of data that designate a private section of length N bytes. The packet 400 may further include a private section 410 of length N bytes. Within the private section 410, two portions of data may also be included; private section item metadata 420 and private section event metadata 430.

The private section 410 of packet 400 may be utilized to facilitate selectable viewing options at a consumer unit. For instance, in FIG. 4, private section 410 includes focal-point metadata and/or vector metadata corresponding to one or more points of interest in the video content 402 (not shown) included in the transport stream. Such focal-point metadata and/or vector metadata may be used to facilitate a consumer system zooming in on and/or following one or more points of interest in Ultra HD video content, although other forms of video content may also be utilized.

Referring to private section 410 in greater detail, the private section item metadata 420 section of packet 400 may include 1 byte of data that corresponds to an identifier, and may include 32 bytes of data corresponding to an item name, such as a point of interest, a player's name, or an actor's name. The item name may also be presented to the user as part of a graphical user interface that allows selection of the item name.

Private section item metadata 420 may further include 1 byte of data that corresponds to the video source type. Examples of video source type may include the Internet, satellite, recorded content, cable, and/or others. Private section item metadata 420 may also include 32 bytes of data that indicate focal-point metadata. For example, focal-point metadata may include coordinates (X, Y) corresponding to a point of interest in the video content 402. In some cases, a consumer system 130 may be configured to zoom in on a sub-frame of a predetermined size that surrounds the focal point. In other cases, the focal-point metadata in the private section 410 may indicate dimensions of the sub-frame. In yet other cases, the focal-point metadata may specify opposing corners of a sub-frame that includes a point of interest (e.g., as two coordinate pairs (X₁, Y₁) and (X₂, Y₂).

Private section item metadata 420 may also include vector metadata that indicates movement (or predicted movement) of a point of interest in video content 402. For example, private section item metadata 420 may include 32 bytes of data that correspond to a direction of movement in the x-direction, 32 bytes of data that correspond to a magnitude of movement in the x-direction, 32 bytes of data that correspond to a direction of movement in the y-direction, and 32 bytes of data that correspond to a magnitude of movement in the y-direction.

Note that the type of data included in the private section 410 may vary and/or include different types of data. Further, the size of the fields shown in private section 410 may vary, depending upon the particular implementation. Further, in some embodiments, focal-point metadata and/or vector metadata may be included as part of an electronic programming guide or advanced programming guide, which is sent to the consumer system 130, instead of being included in an MPEG-2 transport stream.

Still referring to private section 410, the private section 410 may further include private section event metadata 430. The private section event metadata 430 may include 1 byte of data that corresponds to an identifier and 32 bytes of data that indicate an event name. Private section event metadata 430 may further include 4 bytes of data that designate the length X of a description, followed by X bytes of data that provide the description of the video content (e.g., a name of and/or a plot description of a television program). Private section event metadata 430 may also include 1 byte of data that indicates an event type. Examples of event types for television include a movie, sports event, and news, among other possibilities. In addition, private section event metadata 430 may include 1 byte of data that indicates a camera angle type.

In a further aspect, packet 400 may include data that facilitates error detection. For example, the last 32 bytes of packet 400 may include data that facilitates a cyclic redundancy check (CRC), such as points of data sampled from packet 400. A CRC process may then be applied at the consumer system, which uses an error-detecting code to analyze the sampled data and detect accidental changes to the received packet 400.

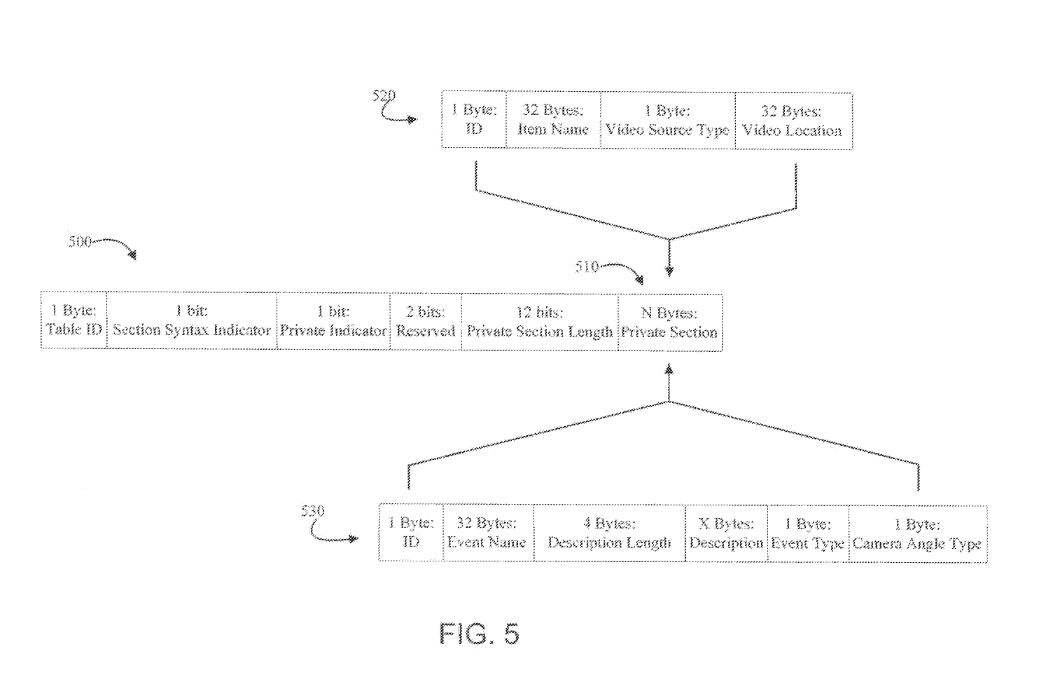

Additionally or alternatively, private section 510 may include additional or different data. The packet 500 has the same general structure as packet 400 but packet 500 may include data related to identification of multiple camera views and a selection of one of those views. For example, FIG. 5 shows a private section 510 with 32 bytes of data indicating the video location (e.g., a video location corresponding to a particular television channel, television frequency, or website universal resource locator).

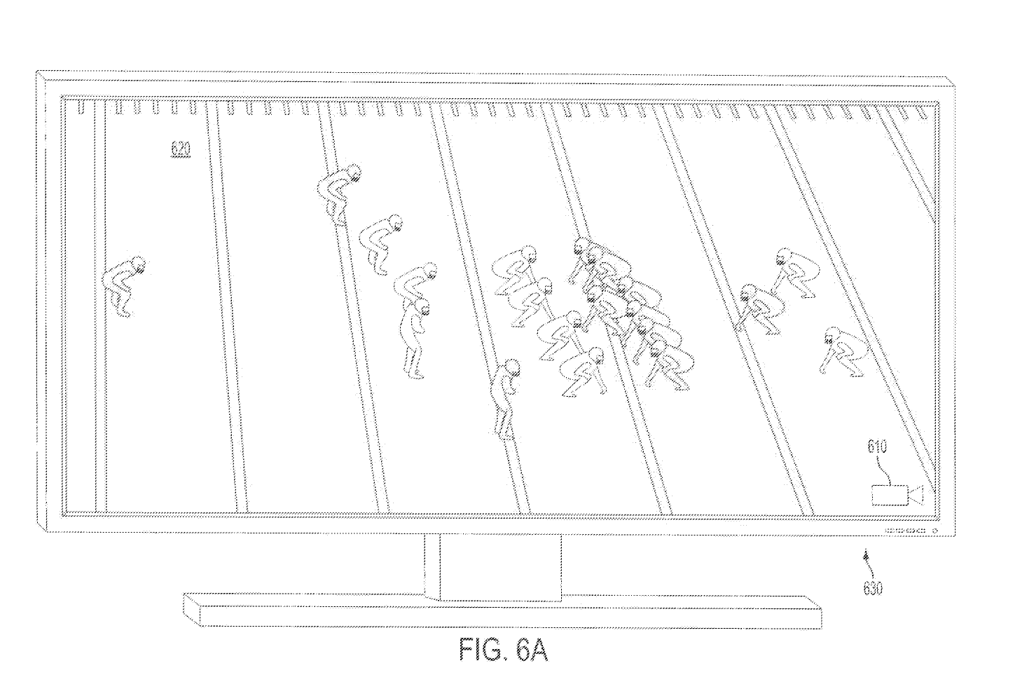

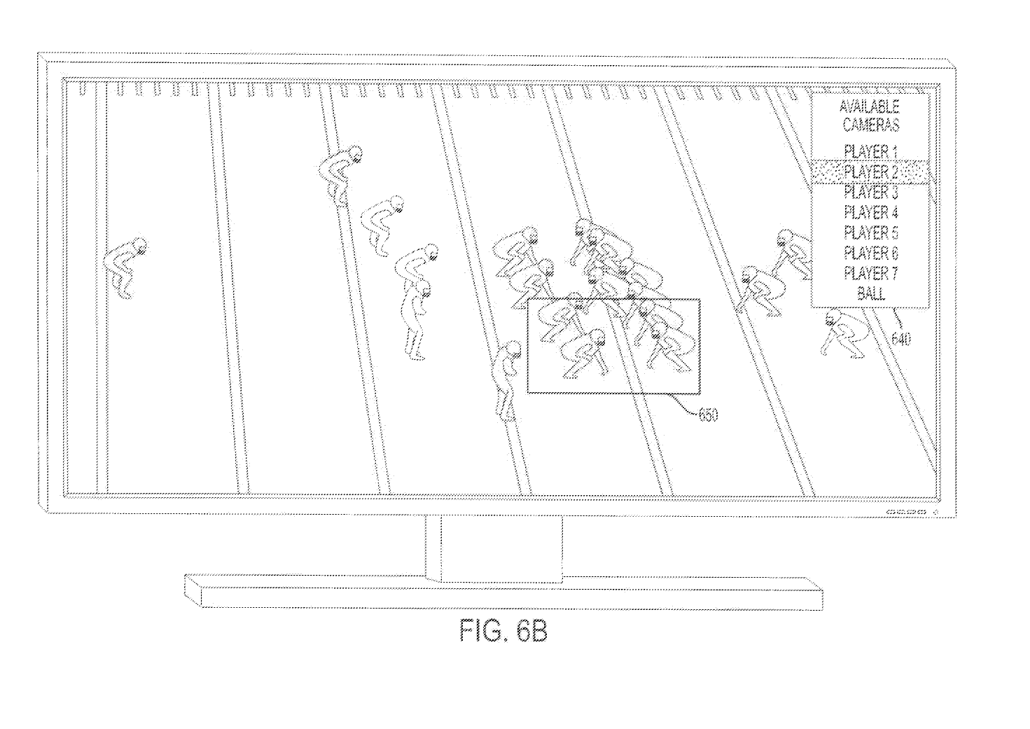

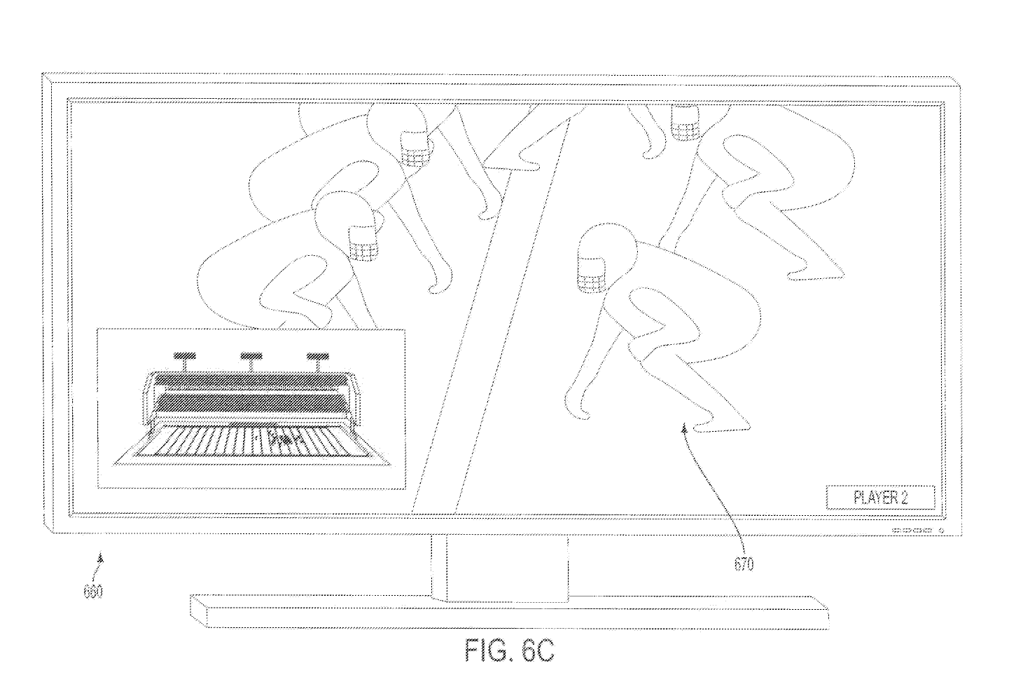

Referring now to FIGS. 6A to 6C, these figures illustrate a scenario in which an exemplary graphical user interface may be provided, which allows a user to select viewing options corresponding to different points of interest in a television program.

Specifically, in FIG. 6A, an icon 610 is displayed in order to notify a viewer that different interactive viewing options are available. In particular, icon 610 may be displayed over video content 620 in a display 630 when focal-point metadata and/or vector metadata is available, such that the viewer can access a graphical user interface (GUI) to select particular points of interest in the video content 620 to zoom in on and follow. When the icon 610 is displayed, the user may provide input (e.g., by clicking a button on a remote control) in order to access a GUI for selectable viewing options. When a consumer system receives such input, the consumer system may display the GUI on the display 630.

In FIG. 6B, the GUI 640 for selectable viewing options is being displayed on the display 630. The GUI 640 provides a user with the option of selecting a point of interest from multiple points of interest. In the illustrated example, the points of interest include different football players and the football. Further, each point of interest (i.e., each football player and the football) may be associated with data such as focal-point metadata, movement metadata, camera metadata, and/or other types of metadata.

The user may navigate through the GUI 640 to select particular points of interest using, e.g., buttons on a remote control for the consumer system 130. Other types of user-interface devices may also be utilized to receive such input.

In an example embodiment, the selection of a particular point of interest via the GUI 640 may be referred to as a zoom request. In the scenario illustrated in FIG. 6B, a zoom request has been received for Player 2. After receiving the zoom request for Player 2, the consumer system 130 processes the video content 620 based on the zoom request (i.e., focal-point input data) and generates a television video output signal that is zoomed in on the point of interest (i.e., Player 2).

For example, the consumer system may initially display a box 650 in the display 630, which indicates the sub-frame surrounding a selected point of interest. The sub-frame may be defined by a coordinate pair that indicates opposing corners of the sub-frame (X₁, Y₁), (X₂, Y₂) within the particular frame of video content, which include the point of interest. Note that when a point of interest is selected via the GUI 640, a box 650 indicating the surrounding sub-frame may or may not be displayed before zooming in on the point of interest, depending upon the particular implementation. For example, the box 650 indicating the sub-frame with the selected point of interest may be displayed momentarily, before zooming in on the sub-frame, or until further input is received from the user to confirm the zoom request. Alternatively, when a zoom request is received, the point of interest may be zoomed in on, without ever displaying a box 650 indicating the sub-frame, within the larger frame of video content.

FIG. 6C illustrates the display 630 after the consumer system 130 has received a zoom request, and responsively zoomed in on Player 2. In particular, once the zoom request is received, the consumer system 130 may begin processing the video content 620 in order to crop the full frames in the transport stream, and generate sub-frames as indicated by the focus-point metadata and/or vector metadata in the transport stream, which correspond to the selected point of interest (e.g., Player 2). Accordingly, the display 630 may display a portion of each frame of video content that is zoomed in on Player 2, effectively providing a view that follows the movements of Player 2 within the frames of the video content 620.

In a further aspect, when a consumer system 130 zooms in on a point of interest, a picture-in-picture display arrangement 660 may be provided. For instance, as shown, a picture-in-picture display arrangement 660 may include the nearly full-screen display of the zoomed-in view of video content 620 of Player 2 670, and the overlaid picture-in-picture display of the full-frame of video content 620 including a larger area of the playing field. In the illustrated example, the zoomed-in view of video content 620 of Player 2 670 is sized to fill the display, and the full-frame view of video content 620 including the larger area of the playing field is displayed in a picture-in-picture format that is overlaid on the zoomed-in view of video content 620 of Player 2 670. In other embodiments, the zoomed-in view of video content 620 of Player 2 670 may be displayed in the smaller picture-in-picture format, which can be overlaid on the full-frame view of video content 620 including the larger area of the playing field. In yet other embodiments, similar content may be provided using split-screen arrangements, other types of picture-in-picture arrangements, full screen arrangements, and/or other types of arrangements.

Note that a similar viewing experience as that illustrated in FIGS. 6A to 6C may be provided when multiple television channels provide different camera views of the same event. In particular, each point of interest may correspond to a different camera view, which is provided on a different television channel. Accordingly, when a zoom request is received that indicates to zoom in on one of the points of interest indicated in GUI 640, the consumer system 130 may responsively tune to the channel providing the camera view that is focused on the selected point of interest.

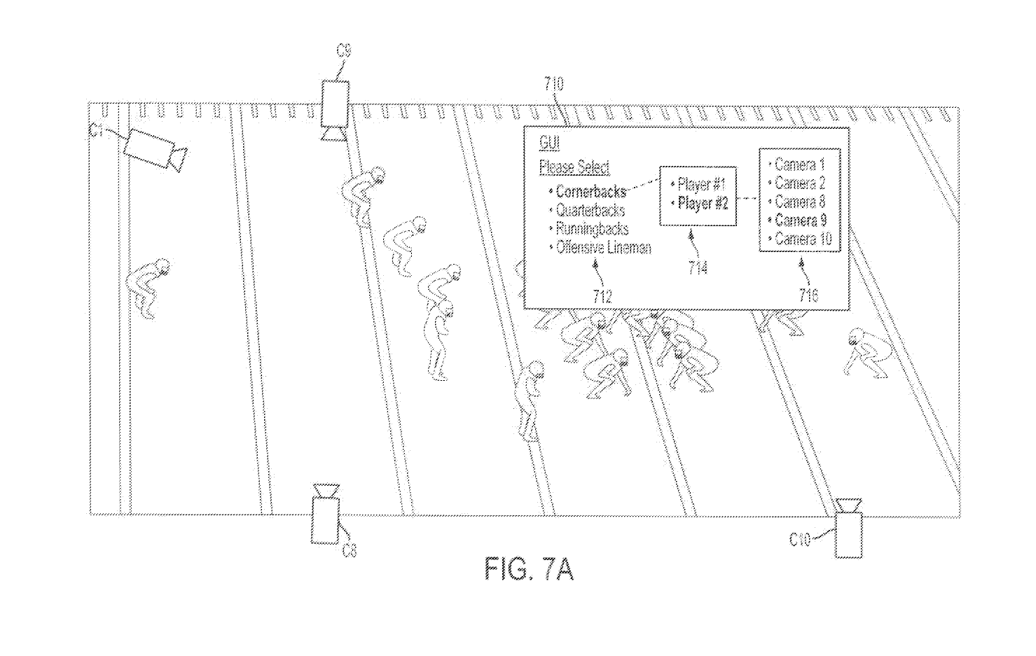

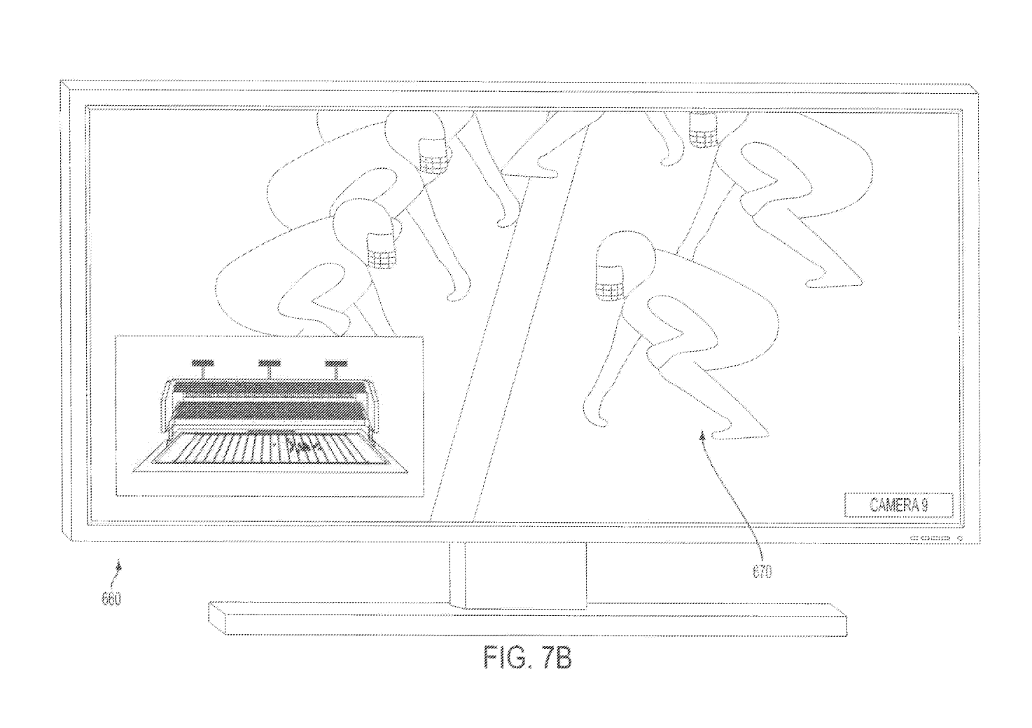

Referring now to FIGS. 7A and 7B, these figures illustrate a scenario in which an exemplary graphical user interface may be provided, which allows a user to select various viewing options from a GUI corresponding to different points of interest in a television program. Specifically, FIG. 7A illustrates an exemplary GUI 710 for zooming in on different points of interest of a video stream. In particular, FIG. 7A shows a television that is displaying a GUI 710 for interacting with a football game that is being broadcast live on a particular television channel. The signal stream for the particular channel may include data that can be used to provide a GUI 710 overlaid on the video of the football game.

The GUI 710 may have a first selection level 712 that is associated with metadata. For instance, the first selection level 712 may be associated with focal-point type metadata (e.g., cornerbacks, quarterback, running backs, coaches, band members, people in the stands). The consumer system 130 may receive a selection request for the first selection level 712 from the user, for example, by the user pressing a button on a remote control. FIG. 7A represents a selection request of cornerback for the first selection level 712.

In a further aspect, the GUI 710 may have a second selection level 714 that may be associated with metadata. For instance, the second selection level 714 may be associated with focal-point metadata. The consumer system 130 may receive a selection request for the second selection level 714 from the user, for example, by the user pressing a button on a remote control. In FIG. 7A, for example, the second selection level 714 is associated with focal-point metadata corresponding to points of interest (e.g., Player 1, Player 2). FIG. 7A illustrates a selection request of Player 1 for the second selection level 714.

In a further aspect, the GUI 710 may have a third selection level 716 that may be associated with metadata. For instance, the third selection level 716 be associated with camera selection metadata. FIG. 7A illustrates different cameras placed around the field with reference numerals C1, C8, C9, and C10. The consumer system 130 may receive a selection request for the third selection level 716 from the user, for example, by the user pressing a button on a remote control. In FIG. 7a, for example, the third selection level 716 is associated with camera selection metadata corresponding to different camera views of the event (e.g., camera 1, camera 2, camera 8, camera 9, and camera 10). FIG. 7A illustrates a selection request of Camera 9 for the third selection level 716.

FIG. 7B illustrates the result of the three selection requests of FIG. 7A; namely, the first selection level 712 of cornerback, the second selection level 714 of Player 1, and the third selection level 716 of Camera 9. As shown in FIG. 7B, Player 1 is centered or featured in a zoomed-in display from the view of Camera 9.

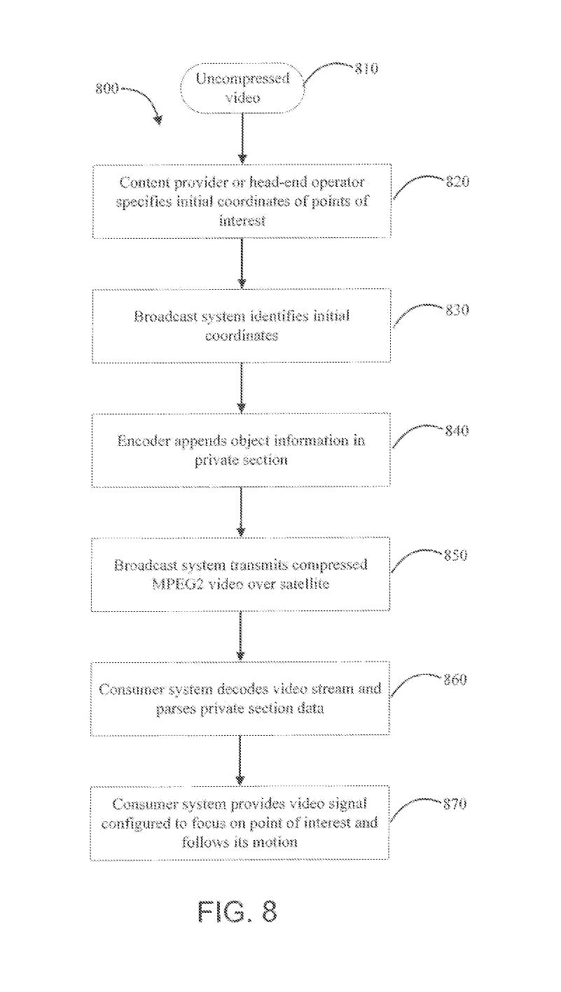

Referring now to FIG. 8, method 800 illustrates an implementation of methods 300 and 350, which utilizes an MPEG-2 transport stream. More specifically, at block 810, uncompressed video is created, such as a live stream for a television program. At block 820, a television program content provider, or a head-end operator, specifies initial coordinates of one or more focus points that follow a point of interest and movement metadata indicating movement of the point of interest. A head-end operator is a facility for receiving television program signals for processing and distribution. The television program content provider may also specify additional data, such as data related to different camera views, data related to types or classifications of points of interest, or other data. Alternatively, the uncompressed video may be received by the broadcast system 120, and the broadcast system 120 may specify initial coordinates, and perform other functions of block 820.

At block 830, the broadcast system 120 identifies the initial coordinates of one or more focus points that follow one or more points of interest in a television program 110. For example, the broadcast system 120 may use a coder-decoder, or codec, to encode the focal-point metadata, movement metadata, and/or other data. At block 840, the broadcast system 120 compresses the uncompressed video and appends data related to the point of interest, such as focal-point metadata and movement metadata, in the private section of the MPEG-2 transport stream. The broadcast system 120 may use a codec compress the uncompressed video and to append the data related to the point of interest in the private section.

At block 850, the broadcast system 120 transmits the compressed MPEG-2 transport stream. For example, the broadcast system 120 may transmit via a satellite television system. At block 860, the consumer system 130 decodes the MPEG-2 transport stream and extracts the private section data, such as the data related to one or more points of interest. The consumer system 130 may be a set-top receiver that decodes the transport stream using a codec or other software. At block 870, the consumer system 130 provides a television video output signal that is configured to focus on the point of interest and follow its motion.

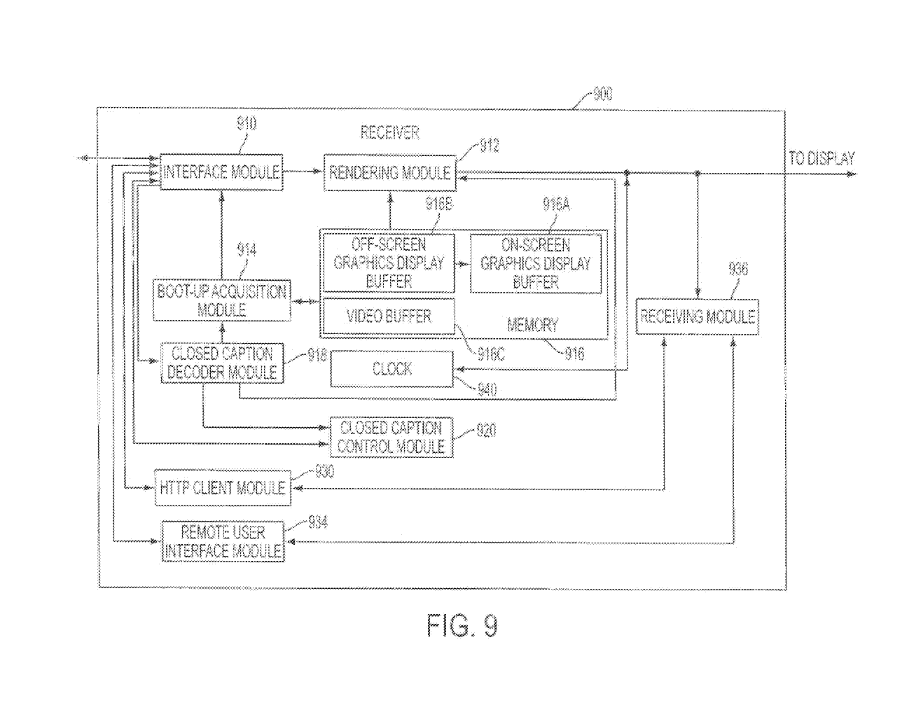

Referring now to FIG. 9, an example embodiment of a receiver is illustrated. A receiver 900 may be one portion of a consumer system 130, as illustrated in FIGS. 1-2. For example, a receiver 900 may be a set-top box of a consumer system. The receiver 900 may include various component modules for use within the local area network and for displaying signals. The display of signals may take place by rendering signals provided from the network. It should be noted that the receiver 900 may comprise various different types of devices or may be incorporated into various types of devices. For example, receiver 900 may be a standalone device that is used to intercommunicate between a local area network and the broadcast system 120 (e.g., a server), as illustrated in FIGS. 1-2. The receiver 900 may also be incorporated into various types of devices such as a television, a video gaming system, a hand-held device such as a phone or personal media player, a computer, or any other type of device capable of being networked.

The receiver 900 may include various component modules such as those illustrated below. It should be noted that some of the components may be optional components depending on the desired capabilities of the receiver 900. It should also be noted that the receiver 900 may equally apply to a mobile user system. For example, a mobile user system may include a tracking antenna to account for the mobility of a mobile user system. This is in contrast to a fixed user system that may have an antenna that may be fixed in a signal direction. The mobile user system may include systems in airplanes, trains, buses, ships, and/or other situations where it may be desirable to have mobility.

The receiver 900 may include an interface module 910. The interface module 910 may control communication between the local area network and the receiver 900. As mentioned above, the receiver 900 may be integrated within various types of devices or may be a standalone device. The interface module 910 may include a rendering module 912. The rendering module 912 may receive formatted signals through the local area network that are to be displayed on the display. The rendering module 912 may place pixels in locations as instructed by the formatted signals. By not including a decoder, the rendering module 912 will allow consistent customer experiences at various consumer systems 130. The rendering module 912 communicates rendered signals to the display of the device or an external display.

In a further aspect, the rendering module 912 may receive content, such as a video transport stream that includes video content associated with a particular television program. The video transport stream may include metadata, for example, metadata described above such as metadata related to a point of interest.

The rendering module 912 may receive data indicating a zoom request. For example, a user of the consumer system 130 may view a graphical user interface on the display and push a button on a remote control associated with the consumer system to indicate a zoom request for a point of interest. Upon receipt of the zoom request, the rendering module 912 may process the video content in response to the zoom request. For example, the rendering module 912 may generate a television video output signal that is configured to be viewable on a graphic display and includes video content that is zoomed to the point of interest chosen by the user of the consumer system 130.

Additionally or alternatively, the receiver 900 may receive and process the video transport stream using different components or methods. For example, the receiver 900 may include a separate video processing system or component (not shown) to receive the video transport stream, to receive the data associated with the zoom request, and/or to generate a zoomed television video output signal.

A boot-up acquisition module 914 may provide signals through the interface module 910 during boot-up of the receiver 900. The boot-up acquisition module 914 may provide various data that is stored in memory 916 through the interlace module 910. The boot-up acquisition module 914 may provide a make identifier, a model identifier, a hardware revision identifier, a major software revision, and/or a minor software revision identifier. Additionally or alternatively, a download location for the server to download a boot image may also be provided. A unique identifier for each device may also be provided. However, the server device is not required to maintain a specific identity of each device. Rather, the non-specific identifiers may be used such as the make, model, etc. described above. The boot-up acquisition module 914 may obtain each of the above-mentioned data from memory 916.

The memory 916 may include various types of memory that are either permanently allocated or temporarily allocated. The on-screen graphics display buffer 916A may be either permanently allocated or temporarily allocated. The on-screen graphics display buffer 916A is used for directly controlling the graphics to the display associated with the receiver 900. The on-screen graphics display buffer 916A may have pixels therein that are ultimately communicated to the display associated with the consumer system 130.

An off-screen graphics display 916B may be a temporary buffer. The off-screen graphics display buffer 916B may include a plurality of off-screen graphics display buffers. The off-screen graphics display buffer 916B may store the graphics display data prior to communication with the onscreen graphics display 916A. The off-screen graphics display buffer 916B may store more data than that being used by the on-screen graphics display buffer 916A. For example, the off-screen graphics display buffer 916B may include multiple lines of programming guide data that are not currently being displayed through the on-screen graphics display buffer 916A. The off-screen graphics display buffer 916B may have a size that is controlled by the server device as will be described below. The off-screen graphics display buffer 916B may also have a pixel format designated by the server device. The off-screen graphics display buffer may vary in size from, for example, hundreds of bytes to many megabytes such as 16 megabytes. The graphics buffers may be continually allocated and deallocated even within a remote user interface session.

A video buffer memory 916C may also be included within the memory 916. The remote user interface may provide the server with information about, but not limited to, the video capabilities of the consumer system 130, the aspect ratio of the consumer system 130, the output resolution of the consumer system 130, and the resolution or position of the buffer in the display of the consumer system 130.

A closed-caption decoder module 918 may also be included within the receiver 900. The closed-caption decoder module 918 may be used to decode closed-captioning signals. The closed-captioning decoder module 918 may also be in communication with rendering module 912 so that the closed-captioning display area may be overlaid upon the rendered signals from the rendering module 912 when displayed upon the display associated with the receiver 900.

The closed-captioning decoder module 918 may be in communication with the closed-captioning control module 920. The closed-captioning control module 920 may control the enablement and disablement of the closed-captioning as well as closed-captioning setup such as font style, position, color and opacity. When a closed-captioning graphical user interface menu is desired, the closed-captioning control module 920 may generate a closed-captioning menu. The closed captioning control module 920 may receive an input from a user interface such as a push button on the receiver 900 or on a remote-control device associated with the receiver 900.

The server device may pass control of the display to the receiver 900 for the closed-captioning menu to be displayed. The menus may be local and associated with the closed captioning control module 920. The menus may actually be stored within a memory associated with the closed-captioning control module 920 or within the memory 916 of the receiver 900.

When the server device passes control to the receiver 900, the closed-captioning menu will appear on the display associated with the receiver 900. Parameters for closed captioning, including turning on the closed-captioning and turning off the closed-captioning may be performed by the system user. Once the selections are made, the control is passed back from the receiver 900 to the server device which maintains the closed-captioning status. The server device may then override the receiver 900 when the closed-captioning is turned on and the program type does not correspond to a closed-captioning type. As will be described below, the server device may override the closed-captioning when the closed-captioning is not applicable to a program-type display such as a menu or program guide.

Communications may take place using HTTP client module 930. The HTTP client module 930 may provide formatted HTTP signals to and from the interface module 910. A remote user interface module 934 allows receivers 900 associated with the media server to communicate remote control commands and status to the server. The remote user interface module 934 may be in communication with the receiving module 936. The receiving module 936 may receive the signals from a remote control associated with the display and convert them to a form usable by the remote user interface module 934. The remote user interface module 934 allows the server to send graphics and audio and video to provide a full featured user interface within the receiver 900. Thus, the remote user interface module may also receive data through the interface module 910. It should be noted that modules such as the rendering module 912 and the remote user interface module 934 may communicate and render both audio and visual signals.

A clock 940 may communicate with various devices within the system so that the signals and the communications between the server and receiver 900 are synchronized and controlled.

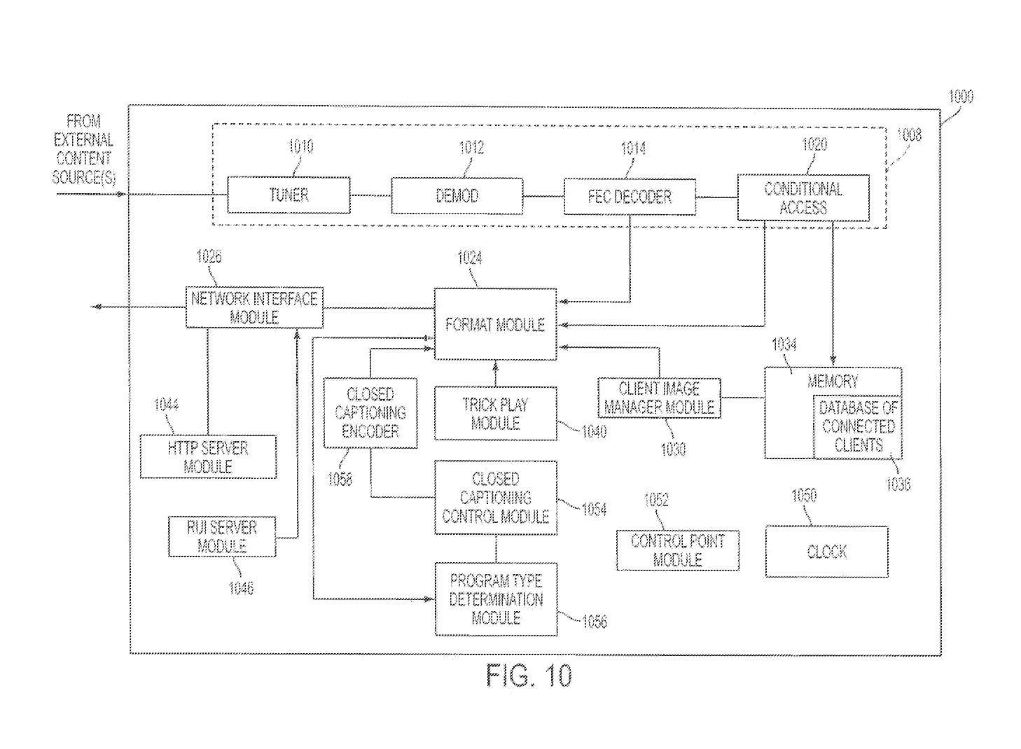

Referring now to FIG. 10, a server 1000 is illustrated in further detail. The server 1000 is used for communicating with all or part of consumer systems 130, such as the receiver 900. The server 1000 may be part of the broadcast system 120, as illustrated in FIGS. 1-2, and, as mentioned above, may also be used for communication directly with a display. In a further aspect, the server 1000 may be a standalone device or may be provided within another device. For example, the server 1000 may be provided within or incorporated with a standard set top box. The server 1000 may also be included within a video gaming system, a computer, or other type of workable device. The functional blocks provided below may vary depending on the system and the desired requirements for the system.

The server 1000 may be several different types of devices. The server 1000 may act as a set top box for various types of signals such as satellite signals or cable television signals. The server 1000 may also be part of a video gaming system. Thus, not all of the components are required for the server device set forth below. As mentioned above, server 1000 may be in communication with various external content sources such as satellite television, cable television, the Internet or other types of data sources. A front end 1008 may be provided for processing signals, if required. When in communication with television sources, the front end 1008 of the server device may include a tuner 1010, a demodulator 1012, a forward error correction (FEC) decoder module 1014 and any buffers associated therewith. The front end 1008 of the server 1000 may thus be used to tune and demodulate various channels for providing live or recorded television ultimately to the consumer system 130. A conditional access module 1020 may also be provided. The conditional access module 1020 may allow the device to properly decode signals and prevent unauthorized reception of the signals.

A format module 1024 may be in communication with a network interface module 1026. The format module 1024 may receive the decoded signals from the decoder 1014 or the conditional access module 1020, if available, and format the signals so that they may be rendered after transmission through the local area network through the network interface module 1026 to the consumer system 130. The format module 1024 may generate a signal capable of being used as a bitmap or other types of renderable signals. Essentially, the format module 1024 may generate commands to control pixels at different locations of the display.

In an example embodiment, the server 1000 receives and processes a video transport stream. For example, the format module 1024 may receive content, such as a video transport stream that includes video content associated with a particular television program. The video transport stream may include metadata, for example, metadata described previously, such as metadata related to a point of interest. The format module 1024 may generate a zoomed television video output signal, based on the received metadata, and transmit the generated television video output signal, for example, to a consumer system 130.

Additionally or alternatively, the format module 1024 may generate metadata, for example, metadata described previously, such as metadata related to a point of interest. For example, the format module 1024 may generate a television video output signal that is configured to be viewable on a graphic display and includes video content that is zoomed to a point of interest.

Additionally or alternatively, the server 1000 may receive and process the video transport stream using different components or methods. For example, the server 1000 may include a separate video processing system or component (not shown) to receive the video transport stream, to receive the data associated with the zoom request and/or to generate a zoomed television video output signal.

The server 1000 may also be used for other functions including managing the software images for the client. A client image manager module 1030 may be used to keep track of the various devices that are attached to the local area network or attached directly to the server device. The client image manager module 1030 may keep track of the software major and minor revisions. The client image manager module 1030 may be a database of the software images and their status of update. A memory 1034 may also be incorporated into the server 1000. The memory 1034 may be various types of memory or a combination of different types of memory. These may include, but are not limited to, a hard drive, flash memory, ROM, RAM, keep-alive memory, and the like.

The memory 1034 may contain various data such as the client image manager database described above with respect to the client image manager module 1030. The memory may also contain other data such as a database of connected clients 1036. The database of connected clients may also include the client image manager module 1030 data.

A trick play module 1040 may also be included within the server 1000. The trick play module 1040 may allow the server 1000 to provide renderable formatted signals from the format module 1024 in a format to allow trick play such as rewinding, forwarding, skipping, and the like. An HTTP server module 1044 may also be in communication with the network interface module 1026. The HTTP server module 1044 may allow the server 1000 to communicate with the local area network. Also, the HTTP server module may also allow the server 1000 to communicate with external networks such as the Internet.

A remote user interface (RUI) server module 1046 may control the remote user interfaces that are provided from the server 1000 to the consumer system 130.

A clock 1050 may also be incorporated within the server 1000. The clock 1050 may be used to time and control various communications with various consumer systems 130.

A control point module 1052 may be used to control and supervise the various functions provided above within the server device.

It should be noted that multiple tuners and associated circuitry may be provided. The server 1000 may support multiple consumer systems 130 within the local area network. Each consumer system 130 may be capable of receiving a different channel or data stream. Each consumer system 130 may be controlled by the server 1000 to receive a different renderable content signal.

A closed-captioning control module 1054 may also be disposed within the server 1000. The closed-captioning control module 1054 may receive inputs from a program-type determination module 1056. The program-type determination module 1056 may receive the programming content to be displayed at a consumer system 130 and determine the type of program or display that the consumer system 130 will display.

The programming-type determination module 1056 is illustrated as being in communication with the format module 1024. However, the program-type determination module 1056 may be in communication with various other modules such as the decoder module 1014.

The program-type determination module 1056 may make a determination as to the type of programming that is being communicated to the consumer system 130. The program-type determination module 1056 may determine whether the program is a live broadcasted program, a time-delayed or on-demand program, or a content-type that is exempt from using closed-captioning such as a menu or program guide.

When the closed-captioning exempt programming is being communicated to the consumer system 130, a closed-captioning disable signal may be provided to the closed-captioning control module 1054 to prevent the closed-captioning from appearing at the display associated with the consumer system 130. The closed-captioning disable signal may be communicated from the closed-captioning control module 1054 through the format module 1024 or network interface module 1026 to the consumer system 130. The consumer system 130 may disable the closed-captioning until a non-exempt programming-type, content-type, or a closed-captioning enable signal is communicated to the consumer system 130. For example, the consumer system 130 may disable the closed-captioning through the closed-captioning control module 920 illustrated in FIG. 9 as part of a receiver 900.

The closed-captioning control module 1054 may also be in communication with a closed-captioning encoder 1058. The closed-captioning encoder 1048 may encode the closed-captioning in a format so that the closed-captioning decoder module 918 of FIG. 9 may decode the closed-captioning signal. The closed-captioning encoder module 1058 may be optional since a closed-captioning signal may be received from the external source.

### IV. CONCLUSION

In some embodiments, any of the methods described herein may be provided in a form of instructions stored on a non-transitory, computer readable medium, that when executed by a computing device, cause the computing device to perform functions of the method. Further examples may also include articles of manufacture including tangible computer-readable media that have computer-readable instructions encoded thereon, and the instructions may comprise instructions to perform functions of the methods described herein.

The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage medium. In addition, circuitry may be provided that is wired to perform logical functions in any processes or methods described herein.

The above detailed description described various features and functions of the disclosed system, devices, and methods with reference to the accompanying figures. While various aspects and embodiments have been disclosed herein, other aspects and embodiments will be apparent to those skilled in the art. The various aspects and embodiments disclosed herein are for purposes of illustration and are not Intended to be limiting, with the true scope and spirit being indicated by the following claims.

1. A method, comprising:
receiving a television video transport stream comprising video content associated with a particular television program, wherein the television video transport stream comprises focal-point metadata regarding at least one dynamic focus point, wherein the at least one dynamic focus point corresponds to a first sub-frame within a first frame of the video content and at least one different sub-frame within a subsequent frame of the video content;
receiving focal-point input data indicating a zoom request;
processing the video content in response to the focal-point input data; and
generating a television video output signal comprising video content that is zoomed to the at least one dynamic focus point, wherein the television video output signal is configured to be displayable on a graphic display.

2. The method of claim 1, wherein the focal-point input data indicating the zoom request is received via a graphical user interface that facilitates a selection of the at least one dynamic focus point.

3. The method of claim 1, wherein generating the television video output signal comprises:
identifying, from the first sub-frame of the television video transport stream and the at least one different sub-frame of the television video transport stream, movement metadata regarding movement of the at least one focus point; and
generating the television video output signal using the focal-point metadata and the movement metadata.

4. The method of claim 3, further comprising:
generating vector metadata; wherein the vector metadata is determined from comparison of the first sub-frame of the television video transport stream and the at least one different sub-frame of the television video transport stream, and wherein the vector metadata comprises both a directional component and a magnitude component.

5. The method of claim 1, wherein the television video transport stream is configured to be displayed at an Ultra HD resolution.

6. The method of claim 1, wherein the focal-point metadata is provided in separate packets of the standard television video transport stream.

7. The method of claim 6, wherein the separate packets are provided via an advanced program guide or through MPEG-2 private section packets.

8. The method of claim 1, wherein the focal-point metadata is provided in a packet header section of a packet.

9. The method of claim 1, wherein a display method of the television video output signal is a picture-in-picture arrangement, a split-screen arrangement, or a full screen display.

10. The method of claim 1, further comprising:
receiving video content associated with a plurality of different camera views of the particular television program, wherein the video data from at least one of the plurality of different camera views comprises focal-point metadata regarding the at least one dynamic focus point;
receiving camera selection input data indicating a camera selection request;
processing the video content in response to the camera selection input data; and
generating a television video output signal comprising video content that is associated with the camera selection input data, the focal-point input data, or the camera selection input data and the focal-point input data, wherein the television video output signal is configured to be displayable on a graphic display.

11. The method of claim 10, wherein the camera selection input data, the focal-point input data, or the camera selection input data and the focal-point input data are obtained by way of a graphical user interface that facilitates a selection of the camera selection input data, the focal-point input data, or the camera selection input data and the focal-point input data.

12. The method of claim 10, wherein the focal-point metadata further comprises a focal-point type.

13. The method of claim 12, wherein the focal-point input data is associated with the focal-point type.

14. The method of claim 13, further comprising:
receiving focal-point type input data indicating a focal-point type request, wherein the focal-point type input data is obtained by way of a graphical user interface that facilitates a selection of the focal-point type, wherein the input data indicating the zoom request is obtained by way of a graphical user interface that facilitates a selection of the at least one focus point;
processing the video content in response to the focal-point type input data; and
generating a television video output signal comprising video content that is associated with the focal-point type input data, wherein the television video output signal is configured to be displayable on a graphic display.

15. An apparatus, comprising:
a receiver configured to:
receive a video transport stream comprising video content associated with a particular television program, wherein the television video transport stream comprises focal-point metadata regarding at least one dynamic focus point, wherein the at least one dynamic focus point corresponds to a first sub-frame within a first frame of the video content and at least one different sub-frame within a subsequent frame of the video content;
receive focal-point input data indicating a zoom request;
process the video content in response to the focal-point input data; and
generate a television video output signal comprising video content that is zoomed to the at least one dynamic focus point, wherein the television video output signal is configured to be displayable on a graphic display.

16. A method, comprising
receiving a plurality of television video transport streams comprising video content for a particular television program, wherein the plurality of television video transport streams comprises video content associated with a plurality of different camera views of the particular television program, wherein each of the plurality of television video transport streams further comprises focal-point metadata regarding at least one dynamic focus point, wherein the at least one dynamic focus point corresponds to a first sub-frame a first frame of the video content and at least one different sub-frame within a subsequent frame of the video content;
identifying the plurality of different camera views;
receiving camera selection input data indicating a camera selection request;
processing the video content in response to the camera selection input data; and
generating a television video output signal comprising video content that is zoomed to the at least one dynamic focus point and associated with the camera selection request, wherein the television video output signal is configured to be displayable on a graphic display.

17. A method, comprising:
receiving streaming data comprising video content associated with at least one live stream for a particular television program;
generating focal-point metadata indicating at least one dynamic focus point, wherein the at least one dynamic focus point corresponds to a first sub-frame within a first frame of the video content and at least one different sub-frame within a subsequent frame of the video content;
generating a television video transport stream comprising video content for a particular television program that includes the focal-point metadata; and
transmitting the television video transport stream by way of a single television channel.

18. The method of claim 17, wherein generating focal-point metadata further includes defining a first pair of coordinates as opposing corners of a first box, wherein the first pair of coordinates represents a first sub-frame with a first frame of the video content and defining a second pair of coordinates as opposing corners of a second box, wherein the second pair of coordinates represents a different sub-frame within a second frame of the video content.

19. The method of claim 17, further comprising:
generating vector metadata indicating a vector point, wherein the vector point is determined by comparing a current focus point sub-frame to a previous focus point sub-frame to generate direction data regarding a direction of movement and magnitude data regarding a magnitude of movement.

20. The method of claim 17, further comprising:
generating identification metadata indicating identification of the at least one live stream; and wherein generating a television video transport stream further includes the identification metadata.

21. The method of claim 17, wherein the television video transport stream is an Ultra HD video transport stream.

22. The method of claim 17, wherein generating a television video transport stream further comprises including the metadata in separate packets.

23. The method of claim 22, wherein the separate packets including the metadata are included in an advanced program guide or are included in an MPEG-2 private section.

24. The method of claim 17, wherein generating the television video transport stream further comprises including the metadata within the packet header section of a packet.

25. A broadcast system, comprising:
a receiver configured to:
receive streaming data comprising video content associated with at least one live stream for a particular television program; and
a signal-generation system configured to:
receive focal-point metadata that indicates at least one dynamic focus point, wherein the at least one dynamic focus point corresponds to a first sub-frame within a first frame of the video content and at least one different sub-frame within a subsequent frame of the video content; and
generate a television video transport stream that comprises video content for a particular television program that comprises the focal-point metadata.

26. The broadcast system of claim 25, wherein the signal generation system is further configured to transmit the television video transport stream.

27. The broadcast system of claim 25, wherein the receiver is configured to receive the focal-point metadata from the streaming data and send the focal-point metadata to the signal-generation system.

28. The broadcast system of claim 25, wherein, in order to receive the focal-point metadata, the signal-generation system is configured to generate the focal-point metadata.
